(19) United States
(12) Patent Application Publication
(10) Pub. No.: US 2006/0062230 A1
(43) Pub. Date: Mar. 23, 2006

(54) Method for testing speech/data channels in a telecommunication network

(76) Inventors: Klaus Bachner, Muenchen (DE); Friedhelm Kreutz, Muenchen (DE)

Correspondence Address: BELL, BOYD & LLOYD, LLC, P. O. BOX 1135, CHICAGO, IL, 60690-1135, US

(21) Appl. No.: 11/224,540

(22) Filed: Sep. 12, 2005

(30) Foreign Application Priority Data
Sep. 11, 2004 (DE) 10 2004 043 960.5

(51) Int. Cl. H04L 12/56

(52) U.S. Cl. 370/401

(57) ABSTRACT

A method for testing speech/data channels in a telecommunication network port wherein existing test functionalities can still be used with respect to IP networks arranged at a transport side. The method includes the steps of integrating a test functionality into a media gateway controller, addressing a speech/data channel, which is connected to a gateway, by the test functionality, selecting the gateway that is closest to the addressed speech/data channel on the basis of a selection function implemented in the test functionality, and performing the test proceeding from this selected gateway.

### FIELD OF TECHNOLOGY

The present disclosure is directed to a method for testing speech/data channels in a telecommunication network.

### BACKGROUND

In order to maintain the function and the high availability of modem telecommunication networks, extensive test methods are required which are implemented according to the suggested standard-comparable guidelines of the ITU and the ETSI, for example. These test methods are sufficiently known and implemented in the TDM world (Time Division Multiplexing).

The German patent 101 35 933, for example, discloses a method for assuring the pass-through of a speech/data channel connection in a telecommunication system wherein the speech/data channel connection occurs via a packet-switched data network between a first and a second media gateway and a first call feature server is provided for controlling at least the first media gateway.

The international patent WO 01/15486 A1 can be cited as an example for controlling media gateways, whereby said patent discloses that events and optional data are added to a protocol used by a media gateway controller (MGC) in order to control a media gateway. These events and data make it possible to monitor the call setup by the MGC without having to wait for the actual setup of the call, so that the entire outlay associated with the implementation of the waiting state is avoided.

As a result of the increasing combination of speech and data transmission in the so-called New Generation Networks (NGN's), the aforementioned findings show that the architecture and the components used therein are fundamentally changing compared to the TDM world. At the same time, previously implemented test methods cannot be directly applied, since the logical data channels (trunk) actually only correspond to the physical data channels with respect to the last mile and the data packets, on the actual transport side, cannot necessarily be transported only via a physical connection.

Accordingly, problems particularly occur in the typically used OAM routines in IP networks wherein the trunk line maintenance functions, in particular, can lead to incorrect test results due to the delays occurring in IP networks. Such functionalities, however, are nowadays already implemented in the so-called soft switches (Media Gateway Controller), so that it is necessary to solve the aforementioned problem of the runtime delay in order to prevent that the functionality of the trunk line maintenance is directly implemented into the respective media gateway.

### BRIEF SUMMARY

A method for testing speech/data channels in a telecommunication network is disclosed wherein existing test functionalities can still be used also in IP networks that are arranged at the transport side.

Under an exemplary embodiment, a method for testing speech/data channels in a telecommunication network is achieved by performing the steps of:
a) integrating a test functionality in a media gateway controller;
b) addressing a speech/data channel, which is connected to a gateway, by the test functionality,
c) selecting the gateway that is closest to the addressed speech/data channel on the basis of a selection function implemented in the test functionality; and
d) performing the test proceeding from this selected gateway.

In this way, it is possible, on the basis of the selection function, to select a monitor or even the monitor that is closest to the speech/data channel to be tested, whereby said monitor is referred to as director in the following. As a result, the delay caused by the IP network is reduced to a minimum in the framework of the required test. Given the test measuring, it is also possible to take a delay offset into consideration from the beginning, whereby said delay offset is unavoidable with respect to the delay.

Under another exemplary embodiment, the speech/data channels operate according to a TDM transmission method and are arranged between a TDM exchange switch and a media gateway. Accordingly, the transmission between the media gateway and the gateway can be based on a packet-switched method, particularly according to an IP protocol.

Under yet another exemplary embodiment, the test functionality can comprise data management of location parameters with respect to the speech/data channel to be tested and of the director allocated to the speech/data channel whereby it is accessed by the selection function. Therefore, said data management can be solved in the form of an allocation table, for example, in which the selection function can search for the respective director for the speech/data channel to be tested.

As was mentioned previously, information about a delay occurring on the transmission path between a director and the responder (which is the network component arranged at the other end of the speech/data channel to be tested) can be crucial as an offset for evaluating the data that are acquired by the test. Therefore, it is beneficial when the location parameters have an entry about the delay on the path of the addressed speech/data channel between the selected gateway and the responder.

For configuration purposes of the test functionality with respect to already existing test routines, it is particularly advantageous when the test functionality initiates the implementation of SS7 protocol stack functions and/or the fetch of the responder functionality of the exchange switch. For example, such functionality can be to the effect that the director, on the side of the responder, requests the insertion of a signal mirror into the speech/data channel so that the runtime of a signal in the speech/data channel and a possibly occurring distortion can be examined in order to be able to make a statement about the state of the speech/data channel.

In order to control the point in time for carrying out a speech/data channel test, there can be specific preference timeframes in an operation-conditioned and/or load-conditioned manner. In order to be able to correspondingly address these preference timeframes by the media gateway controller (soft switch), the media gateway can request a test of a specific speech/data channel at the media gateway controller and potentially can even communicate a timeframe within which this test routine should be performed.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 illustrates a communication network under an exemplary embodiment, where, a backbone on the transport side, network NW includes a transport part IP that operates according to the Internet protocol and speech/data channels TDM that directed to the subscriber and that operate according to a timeslot-oriented method.

### DETAILED DESCRIPTION

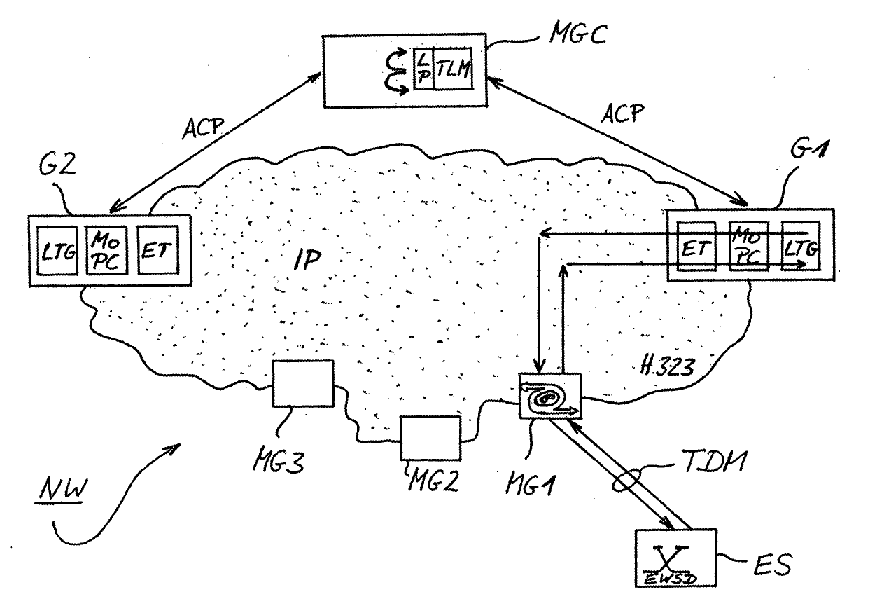

Gateways G1 and G2 and media gateways MG1 to MG3 are provided in FIG. 1 for transporting the data in the transport part IP whereby said media gateways MG1 to MG3 effect the re-signaling of the data from the TDM world into IP world. Given the exchange at the subscriber side with respect to the speech/data channels TDM, only a trunk exchange server ES is arranged as an example whereby said exchange server ES comprises an EWSD switching center, for example, and provides a V5.2 interface for the subscriber lines (or loops). EWSD represents for the timeslot-oriented switching system “Elektronisches Wahlsystem Digital” (Electronic switching system digital) developed by Siemens AG.

In order to effect the data transport, the gateways G1 and G2 exhibit a first functionality ET for the Ethernet Framing of the data packets to be transported. Furthermore, the gateways G1 and G2 have a modem pool card MoPC and a line trunk group LTG exhibiting a functionality as a director for testing the speech/data channels TDM.

Media gateway controller MGC controls and monitors the media gateways MG1 to MG3 and gateways G1 and G2. Data exchange between media gateway controller MGC and gateways G1 and G2 occurs via access control protocol ACP. Among other things, media gateway controller MGC also has the functionality of the trunk line maintenance TLM, which makes it possible to test the properties of a speech/data channel TDM arranged at the side of the TDM. Due to the unpredictable delay times of the data transmission in the transport part IP, it is necessary for this test, dependent on the speech/data channel TDM to be tested, to find a gateway for this speech/data channel TDM that has director property. The gateway should preferably be as close as possible to speech/data channel TDM. In order to be able to find the closest gateway G1, the media gateway controller MGC, in the framework of its TLM test functionality, executes a selection function which, among the location parameters LP, determines the gateway that is allocated to this speech/data channel TDM. A component of these location parameters LP can also be an offset value for the delay which occurs, anyway, with respect to the speech/data channel connection from the trunk exchange server to the media gateway MG1 and/or with respect to the IP connection from the media gateway MG1 to the gateway G1. As shown by arrows in FIG. 1, the gateway G1 has been selected for testing the speech/data channels TDM under the exemplary embodiment. The media gateway controller MGC instructs the gateway G1 to execute the actual test routines. The test routines can be routines that are standardized in the signaling system 7 (SS7 according to Q.701 to Q.707). Given this type of test routines, the gateway G1 prompts the corresponding media gateway MG1 to execute the test with respect to the trunk exchange server ES, whereby a mirror, for this purpose, is inserted into the speech/data channel TDM to be tested on the side of the trunk exchange server ES, for example. Therefore, the mirror (rather representing a line termination having total reflection of an electromagnetic wave—in the electrotechnical sense) reflects the test signal originating from the gateway G1. The required runtime and the distortion/attenuation potentially superimposing the test signal enable the gateway G1 to communicate the state of this physical speech/data channel TDM.

Alternately, the media gateway MG1 may quasi register at the media gateway controller MGC for the test of the speech/data channels allocated to it. In this way, a timeframe, for example, which is advantageous for the test and within which a test can be carried out later, can be indicated to the media gateway controller MGC. Such a timeframe can be characterized by an expected low load of the speech/data channels, for example. On the basis of this timeframe information, the media gateway controller MGC can call and monitor the test routines as described above.

The previous exemplary embodiment has been described in the context of allocation of test routines with respect to speech/data channels that are arranged at the TDM side. It is understood that it is also possible to test other objects in the network NW, which are arranged closer to the side of the subscriber, for example, such as an integrated access device, a network termination unit etc., with respect to their functionality given the above-described method.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

List of Used Reference Characters

| | |
|---|---|
| ACP | Access Control Protocol |
| ES | Trunk Exchange Server |
| ET | Ethernet Framing |
| G1, G2 | Gateways |
| H.323 | Ethernet transmission standard |
| IP | Internet Protocol |
| LP | Location Parameter |
| LTG | Line Trunk Group |
| MGC | Media Gateway Controller |
| MG1 to MG3 | Media Gateways |
| MoPC | Modem Pool Card |
| NW | Network |
| TDM | speech/data channel in Time Division Multiplexing |
| TLM | Trunk Line Maintenance |

The invention is claimed as follows:

1. Method for testing speech/data channels in a telecommunication network, comprising the steps of:
a) integrating a test functionality into a media gateway controller;
b) addressing a speech/data channel, that is connected to a gateway, by the test functionality;
c) selecting the gateway, which is closest to the addressed speech/data channel, by a selection function implemented in the test functionality;
d) performing the test proceeding from this selected gateway.

2. The method according to claim 1, wherein the speech/data channels operate according to a TDM transmission method and are arranged between a TDM exchange switch and a media gateway.

3. The method according to claim 1, wherein the transmission between the media gateway and the gateway is based on a packet-switched method, particularly according to IP protocol.

4. The method according to claim 1, wherein the test functionality comprises a data maintenance of location parameters with respect to the speech/data channel to be tested and a director allocated to the speech/data channel, whereby the selection function accesses said test functionality.

5. The method according to claim 4, wherein the location parameters comprise an entry with respect to the delay on the path between the addressed speech/data channel and the selected gateway.

6. The method according to claim 4, wherein the test functionality initiates the realization of SS7 protocol stack functions and/or the call of the responder functionality of the exchange switch.

7. The method according to claim 6, wherein the director requests the insertion of a signal mirror into the speech/data channel on the side of the responder.

8. The method according to claim 1, wherein the media gateway requests a test of a specific speech/data channel at the media gateway controller.
